(19) United States
(12) Patent Application Publication
(10) Pub. No.: US 2013/0099096 A1
(43) Pub. Date: Apr. 25, 2013

(54) FLASH DETECTION AND LASER RESPONSE SYSTEM

(71) Applicant: Optical Physics Company, Calabasas, CA (US)

(72) Inventor: Richard A. Hutchin, Calabasas, CA (US)

(73) Assignee: Optical Physics Company, Calabasas, CA (US)

(21) Appl. No.: 13/651,561

(22) Filed: Oct. 15, 2012

Related U.S. Application Data
(60) Provisional application No. 61/550,007, filed on Oct. 21, 2011.

(51) Int. Cl. B01J 19/12; H01L 27/146

(52) U.S. Cl. 250/208.1

(57) ABSTRACT

A flash detection and laser response system includes a flash sensor configured to capture a plurality of sensor images, an image analyzer configured to identify at least a first image including a first flash event and to compute from the first image a direction of the flash event relative to the flash sensor, a laser, and a steering mechanism coupled to the laser and configured to steer disabling light from the laser in the direction of the flash event.

### BACKGROUND OF THE INVENTION

1. Field of the Invention

The field of the present invention relates to a system for detecting, classifying, and locating flashes, in particular flashes caused by the firing of guns, rifles, and artillery, and directing an energy weapon toward the detected flash.

2. Background

There are a significant number of occasions in combat where there is an acute need for rapid defensive action against a threat. One example scenario involves troops entering an urban area where there are hostile enemy combatants. These combatants can pop up, shoot, and drop back or flee before their position can be identified for counter attack. While there are sensors that can determine the general location of the threat from acoustic and/or spectral signatures, the threat can be long gone before counter fire can be initiated.

Another example is small arms fire against a helicopter where rapid detection and identification of the threat is highly desirable for taking evasive action to avoid the threat or for a counter attack to neutralize the threat. Similarly, perimeter defense in a fire fight and neutralizing a sniper are situations where rapid detection and rapid response are of paramount importance.

Some of the many technical challenges associated with detecting, localizing, and rapidly responding to hostile gunfire are caused by the many false alarms that may appear like a gunfire or artillery flash, but occur due to natural and other man-made phenomena such as solar reflections from passing cars and flares from cigarette lighters. Other challenges arise due to the short duration of the flash and the need to scan a wide area fast enough to detect the short duration flashes.

### SUMMARY OF THE INVENTION

The present invention is a system that combines a flash sensor, an image analyzer to identify a flash event, and a laser coupled to a steering mechanism configured to respond to the flash event. A method for operating such a system is also disclosed. The flash sensor is configured to capture a plurality of sensor images, and the image analyzer is configured to identify at least a first image, from among the captured sensor images, which includes a flash event, and to compute from the first image the direction of the flash event, relative to the flash sensor. The steering mechanism responds to the flash event by directing disabling light from the laser in the direction of the flash event. The disabling light may be a laser beam or a laser pulse.

The system may further include a flash tracker which captures at least one tracker image of the flash event. The image analyzer is further configured to compute from the tracker image, or images, a second direction of the flash event, with the second direction of the flash event being more accurate than the direction computed from the sensor image.

The system may be further configured to discriminate a detected flash event based upon characteristics of the flash event such as one or more of the time profile, the intensity, the angular size, spectral characteristics, the direction, and the distance to the flash event. One or more of these characteristics may aid the system in determining whether a flash event originated from a hostile or friendly source, and subsequently direct the disabling light if the source is determined to be hostile.

Accordingly, a flash detection and laser response system is disclosed. Advantages of the improvements will appear from the drawings and the description of the preferred embodiment.

### BRIEF DESCRIPTION OF THE DRAWINGS

In the drawings, wherein like reference numerals refer to similar components:

FIG. 1 schematically illustrates a flash detection and laser response system;

FIG. 2 illustrates a generalized procedure for operating the flash detection and laser response system of FIG. 1;

FIG. 3 illustrates a two step laser steering procedure suitable for operating a flash detection and laser response system; and

FIG. 4 illustrates a procedure for operating the flash detection and laser response system.

### DETAILED DESCRIPTION OF THE PREFERRED EMBODIMENTS

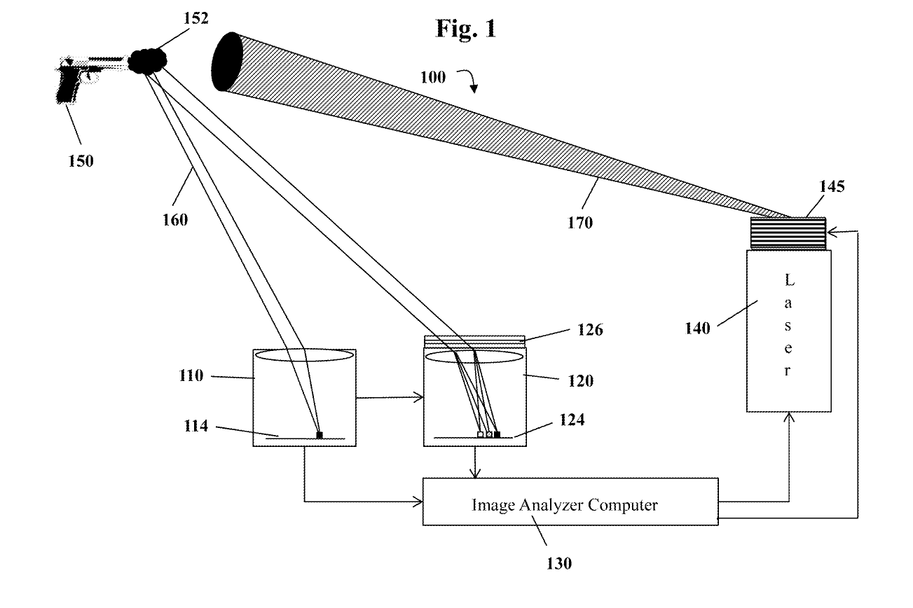

Turning in detail to the drawings, FIG. 1 illustrates a flash detection and laser response system 100. The system 100 includes a flash sensor 110, a flash tracker 120, an image analyzer 130, and a laser 140 coupled to a beam steering mechanism 145. Image frames are acquired by the flash sensor 110 and sent to the image analyzer 130, which may be a programmed computer or any other type of hardware- or software-implemented image processor. The image analyzer 130 processes the image frames to determine if a flash event 152 is detected in one or more of the images. If a flash event 152 is detected in an image, the image analyzer 130 preferably determines if the flash event 152 originates from a hostile source. If the flash source 150 is determined to be a hostile weapon, then the laser 140 may be used as a directed energy weapon for counter-attack. For this decision, multiple features of the image frames registering the flash 152, such as its duration, size, approximate location and possibly spectral characteristics are processed by the image analyzer 130. This analysis may include comparisons to existing templates already determined to be from hostile sources. If the image analyzer 130 determines that the flash 152 originated from a hostile source, then the image analyzer 130 further determines the approximate direction from which the hostile flash 152 originated. This approximate direction finding and the time of the flash are communicated to the tracker 120 which in turn provides a much more accurate direction to the image analyzer 130. The image analyzer 130 then computes the azimuth and elevation of the flash source 150 and communicates these to the laser steering mechanism 145 which is configured to direct the laser beam from the laser 140 towards the flash source 150. The laser 140 is activated and a laser beam or a laser pulse 170 is sent towards the flash source 150. The settings and activation of the laser 140 may be conditional on the type of flash 152 registered. For example, if the flash source 150 is determined to be a hostile weapon, the laser 140 may be configured at a high setting to destroy the hostile weapon or the attacker using the hostile weapons. On the other hand, if the type of phenomenon or device or weapon causing the flash 152 is unknown, the laser 140 may be configured as a laser imager to illuminate the area to obtain an image of the flash source 150 and make a determination. If the distance to the flash source 150 is needed to determine the nature of the flash 152 or the power level of the outgoing laser beam or laser pulse 170, a laser range finder may be used.

The flash detection and laser response system 100 can be used in many military scenarios. It can be mounted on a ship, on a military land vehicle, on a soldier's helmet, on a helicopter or other aircraft.

The flash sensor captures a time sequence of images of the scene which may contain one or more flashes that are caused by discharging of weapons. The scene may also contain no weapon flashes or contain flashes that are caused by other man made or natural phenomena such as glints from reflecting surfaces, lighting of matches and cigarette lighters. Multiple images may correspond to multiple images of the scene at a single instant in time captured in different spectral bands, e.g., visible band and mid-wave infrared (MWIR) band, or multiple time image frames of the scene, or a combination thereof.

In FIG. 1, the flash sensor 110 is shown to contain only one detector array 114. The flash sensor 110 may be modified to contain multiple detector arrays. Multiple detector arrays may register different parts of the scene. These detector arrays may be one or two dimensional. One example is to couple multiple linear detectors to a fisheye lens so that approximate azimuth and elevation can be inferred from the position of the activated detectors in the linear detector array.

Multiple detector arrays may also be used by the flash sensor 110 to image of the scene in different spectral bands, e.g., one detector array registers the visible band whereas a second detector array registers the MWIR band image. Having multiple band images may provide additional information for analyzing the nature of the flash 152 and the nature of the flash source 150, which in turn helps determine whether the flash originated from a hostile or non-hostile source. Generally, many flashes due to weapon discharge will stand out in images acquired in the MWIR band much better than they would in images acquired in the visible band. Therefore, it may be highly desirable to use at least one detector array that captures images in the MWIR band.

Often the hostile action may originate anywhere in the full hemisphere or extended hemisphere surrounding the flash sensor 110. Since a flash event will usually very short, typically a few milliseconds, the flash sensor 110 may need to be pointed in the direction of the flash in order to register it. Consequently, a very wide field of view flash sensor 110 is desirable. Several options are available to expand the field of view of the flash sensor 110. One option is to optically couple a fish eye lens to the sensor so that it captures a full hemisphere field of view. A second option is to use multiple flash sensors, each pointed in a different direction to cover the full hemisphere or all directions from which hostile action can originate. For example, six flash sensors each with a 60 degree horizontal field of view can be used to image the full 360 degree field surrounding a single point.

Determining the precise direction of the flash is of paramount importance for success in disabling a hostile source. Consider a flash that is 30 cm in diameter. At a distance of 1 km, the flash will measure only 1 arc minute ( 1/60^{th} of a degree, or 0.3 milliradians) in the field of view. To aim the steering mechanism 145 effectively, it is estimated that 3 cm detection accuracy at 1 km is appropriate (30 microradians). For a detector array of 256×256 picture elements (pixels) coupled to the fish eye lens, the elevation resolution is about 1.4 pixels per degree and the azimuth resolution is at best 2.2 pixels per degree. Depending upon the circumstances in which the system is used, this resolution may not be sufficient to locate the hostile source with a sufficiently high precision.

This potential limitation is overcome by inclusion of the flash tracker 120. While the flash sensor 110 captures images of the scene, the flash tracker 120 simultaneously monitors the scene for flashes. The rate of image capture (frame rate) may be different between the flash sensor 110 and the flash tracker 120 with the flash sensor 110 frame rate typically being higher. The images captured by the flash sensor and the images captured by the flash tracker are time stamped to identify and locate corresponding flash events. Furthermore, the boresights of the flash sensor and the flash tracker are aligned to a degree that permits the identification of corresponding flash events in space. The images from the flash tracker that contain flashes determined by the image analyzer to be hostile are further analyzed and processed. The flash tracker images provide accurate angular coordinates of the hostile source. The flash tracker may be omitted if the hostile source angular coordinates that can be computed using the flash sensor images are sufficiently accurate for the mission at hand.

The flash tracker 120 monitors the scene and acquires images of the scene that register the flash or flashes in the scene. The flash tracker 120 may also employ additional optical elements to determine the azimuth and elevation of the flash 152 far more accurately than the flash sensor 110. One optical element that can be used for tracking the relative angular position of a flash is an interferometric block 126. Before reaching the detector 124 of the flash tracker 120, the light emanating from the flash 152 passes through the interferometric block 126. The result is that the flash image on the detector array 124 is broken up into several separate images whose intensities change sinusoidally as the center of the flash 152 moves across the field of view. The position of these images on the detector 124 provides a standard coarse angle estimate in addition to the estimate from the flash sensor 110. The intensity values of the multiple flash images are used for phase analysis, to yield a more precise angle estimate.

A device and method of tracking the angular position of a light source are disclosed in U.S. patent application Ser. No. 12/057,912, filed Mar. 28, 2008, the disclosure of which is incorporated herein by reference in its entirety. The interferometric block 126 may be constructed according to the teachings of the referenced patent application. The interferometric block 126 may increase the accuracy of the flash tracker 120 by a factor of 1000 or more over the accuracy possible with the flash sensor 110 alone.

In FIG. 1, the flash tracker 120 is shown to contain only one detector array 124. The flash tracker 120 may be modified to contain multiple detector arrays. Multiple detector arrays may register different parts of the scene. These detector arrays may be one or two dimensional. One example is to couple multiple linear detectors to a fisheye lens so that approximate azimuth and elevation can be inferred from the position of the activated detectors in the linear detector array.

As previously explained, hostile action may originate anywhere in the full hemisphere or extended hemisphere surrounding the flash tracker 120. Since the flash event is usually very short, typically a few milliseconds, the flash tracker 120 may need to be pointed in the direction of the flash in order to register it. Consequently, a very wide field of view flash tracker 120 is desirable. Several options are available to expand the field of view of the flash tracker 120. One option is to optically couple a fish eye lens to the flash tracker so that it captures a full hemisphere field of view. A second option is to use multiple flash trackers, each pointed in a different direction to cover the full hemisphere or all directions from which hostile action can originate. For example, six flash trackers each with a 60 degree horizontal field of view can be used to image the full 360 degree field surrounding a single point.

The image analyzer 130 may be a computer with appropriate data acquisition and storage capabilities and a processor. The images are acquired from the flash sensor 110 and stored in memory. The processor is programmed with routines that detect the presence of a flash, determine its pertinent features, such as approximate size, time profile, angular position and spectral characteristics. These features are then studied and compared to existing templates to determine whether the flash was caused by a natural phenomenon, or a non-hostile man-made action, or a weapon. A flash caused by a weapon may further be analyzed to determine the particular type of weapon from which it originated, e.g., an AK-47 assault rifle or RPG-7 shoulder launched rocket propelled grenade, such as by comparison of known weapon spectral characteristics. A flash may also be analyzed to determine its approximate location which could help indicate whether the weapons fire is friendly or hostile.

If the flash source is determined to be potentially hostile, then the image analyzer 130 computes and communicates the location and the time of the flash to the flash tracker 120. The flash tracker 120 sends the image frame or frames acquired by the flash tracker 120 that register the same flash to the image analyzer 130. Alternately, the flash tracker 120 may send all image frames it acquires to the image analyzer 130 which in turn can be programmed to identify corresponding image frames between the flash sensor 110 and the flash tracker 120. The image frames from the flash tracker 120 are further analyzed to determine a more accurate estimate of the direction of the flash 152 and/or the flash source 150. The image analyzer 130 then communicates the azimuth and elevation of that direction to the steering mechanism 145. Flash direction determination may be determined solely on the image frames from the flash sensor 110 if precision is not necessary. Once the steering mechanism 145 is configured to aim the beam from the laser 140 in the direction of the flash 152 or the flash source 150, the image analyzer 130 issues a command to activate the laser 140. The image analyzer 130 may issue additional commands that set several characteristics of the laser 140, such as the beam diameter, power level, wavelength, or duration of the pulse emitted from the laser prior to activating the laser 140. These settings may further depend upon the location, distance and type of the source of the flash, as well as on mission objectives.

The laser 140 is a directed energy weapon capable of emitting a continuous wave (CW) or a pulsed laser source at a number of wavelengths, such as ultraviolet, visible, or infrared. When pulsed laser is employed, the pulses are preferably less than 1 second in duration. The power level of the laser may be set based on the mission objectives. A laser used as a non-lethal weapon such as a dazzler will have a lower power setting than one used to damage a missile seeker. Likewise, different wavelengths of laser beams have different damage characteristics.

The laser is steered to aim in the direction of the hostile source provided from the flash tracker and activated to emit a laser beam or laser pulse towards the threat source. The combination of a reliable flash sensor combined with an accurate flash tracker integrated with a <100 millisecond steerable laser source results in an effective tool which can be used to counter-attack the threat within a small fraction of a second from the time of flash. A type of non-mechanical beam steering which is capable of meeting this fast steering requirement is described by McManamon, Paul F. et al., “A Review of Phased Array Steering for Narrow-Band Electrooptical Systems”, Proceedings of the IEEE, Vol. 97, No. 6, June 2009. By having a fast steering time period, the response time for the system is anticipated to be too short for the attacker or the attacking platform to have moved significantly to flee or take cover. Hence, the laser source, depending on the wavelength and energy used, will dazzle, blind, burn, kill or otherwise disable the attacker, or disrupt or disable the visual target acquisition capability of the attacker almost instantaneously after the attack.

Such a fast system is unprecedented and may substantially change the force balance in the field. At the very least, it will force the enemy to take burdensome defensive and evasive precautions which will substantially reduce the effectiveness of hostile enemy actions. The ability of the enemy to quickly fire at targets of opportunity will be heavily compromised with great benefit to friendly forces.

Optionally, an external range finding device may be utilized to gauge the distance to the threat. This information in turn may be used to adjust the duration or energy level of the laser pulse in order to achieve the desired intensity at the target. The laser range finder operates on the time of flight principle. After a pulse is sent, its reflection is detected. The duration between the pulse sent and the return is a measure of the distance to the flash source. For a source that is 1 km away, the time between the pulse and the detection of the reflected return is less than 7 microseconds.

The steering mechanism 145 may be an electrically tunable liquid crystal grating configured to bend the laser beam or laser pulse 170 emitted from the laser 140 towards the flash 152 or the source of the flash 150. Additional options are steerable mirrors, gimbals or rotating prisms. A key feature is the ability of the system to point open loop to high accuracy in millisecond time periods so that the laser response will be precisely on target very quickly. This generally implies that the boresights of the flash sensor 110, flash tracker 120, and the steering mechanism 145 are referenced to and track the movement of one another.

One caution for this system is the potential for friendly fire when it is used as a counter-attack weapon. In a complex scenario where friendly forces are intermingled with enemy forces, it will be important to have suitable discrimination. Some of this discrimination may rely on measurements obtained using the system, e.g., distance to the flash source based on flash size or weapon type based on spectral characteristics of the flash, or obtained using external sensors such as a range finder device.

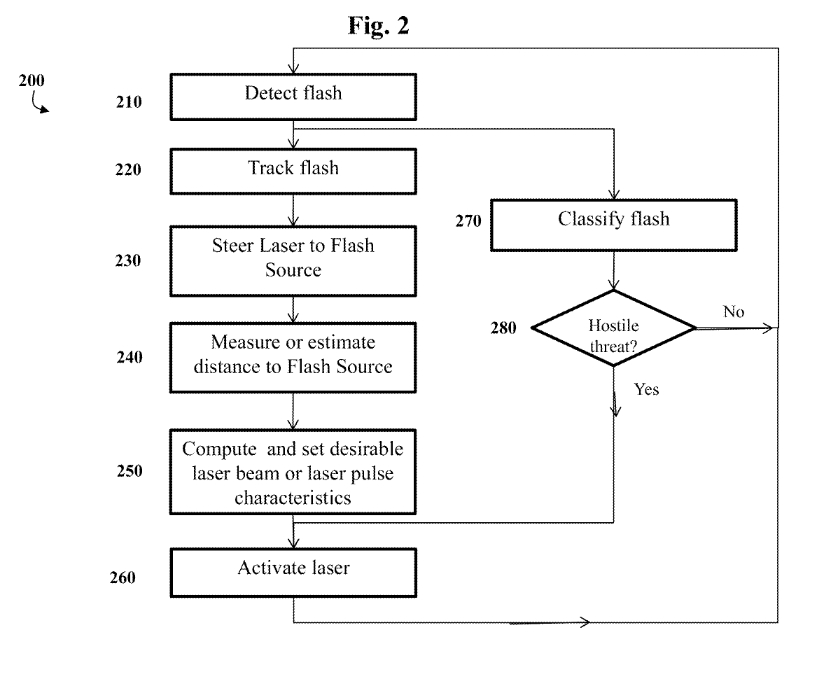

A generalized procedure 200 for operating the flash detection and laser response system 100 is shown in FIG. 2. The procedure flowchart shows seven steps and one decision point 280. While the classification step 270 is shown between the detection step 210 and the tracking step 220, this classification step 270 can also be carried out in parallel with any one or more of the other intermediate steps or inserted in between any of the other steps. Likewise, the steering step 230 may also be carried out in parallel with any one of the tracking step 220, the distancing step 240, the computation step 250, and the classification step 270. If the steering step 230 is carried out in parallel with the tracking step 220, it is preferable to use the final high precision estimate of azimuth and elevation from the tracking step 220 to point the laser. Furthermore, one or more of the tracking step 220, the distancing step 240, and the computation step 250 may be omitted. Omitting the tracking step 220 is likely to result in a low precision target hit. Based on the generalized procedure 200, two minimal procedures may be described as below:
Minimal Procedure 1: the detecting step 210, followed by the classification step 270, followed by the hostility decision point 280, followed by the detection step 210 (if the decision point 280 results in a “no”) or the steering step 230 (if the decision point 280 results in a “yes”). The steering step 230 is then followed by the laser activation step 260.
Minimal Procedure 2: the detecting step 210, followed by the steering step 230, followed by the classification step 270, followed by the hostility decision point 280, followed by the detection step 210 (if the decision point 280 results in a “no”) or the laser activation step 260 (if the decision point 280 results in a “yes”).

All of the steps in the generalized procedure 200 need to be carried out in a very short period of time for the system 100 to be effective. To be effective, the entire procedure from the occurrence of the flash to activation of the laser may take approximately 10-100 milliseconds. This is one of the reasons why it is desirable to overlap the execution of some steps, or to carry out more than one step at the same time. The following is a more detailed description of each of the steps.

A flash event is detected in detection step 210. Detecting a flash event involves using the flash sensor 110. The flash sensor 110 continuously acquires, preferably at 1 KHz or faster, images of the scene. Image frames are analyzed to determine if any flash is present. The determination can be based a threshold intensity, a timing profile of the intensity and/or observation of certain spectral characteristics. Acoustic sensors may also be employed although they are generally too slow. If a potential flash event is detected, its features, such as its duration, size and spectral characteristics, as well as its approximate azimuth and elevation are computed. At this point, the flash event is more closely analyzed in the classification step 270 to determine whether or not it originated from a hostile source and whether or not it is a threat that should be eliminated, disabled or deterred. The classification step 270 may involve analysis of the flash features to classify the flash as a natural phenomenon, a non-hostile man-made event, or a weapon discharge. A flash classified as a weapon discharge may be further analyzed to determine if it came from a friendly or enemy weapon. This analysis may take into consideration data coming from external sources, such as known positions of friendly and enemy weapons and troops.

The flash detection step 210 provides a coarse estimate of azimuth and elevation of the flash source. However, it is highly preferable to track the flash (step 220) to improve this coarse estimate and provide a much more accurate position, generally on the order of 0.5 milliradians or better. The use of the flash tracker 120 to track the flash involves identifying the corresponding image frames between the flash sensor 110 and the flash tracker 120. This is a simple task provided that the image frames from the flash sensor 110 and the image frames from the flash tracker 120 contain adequately precise timing and the direction information. Once the direction from which the flash originated is known, the laser is steered using the steering mechanism 145 towards that direction in the steering step 230. Optionally, to reduce the time duration of steering, the steering step 230 may be initiated once the coarse direction is known (step 210). The steering step 230 may then carry out a final fine adjustment once the flash tracking step 220 supplies a more precise azimuth and elevation estimate for the flash source.

Optionally, as prescribed in the distancing step 240, the distance to the flash source may be estimated. This estimation may be based on the angular size of the flash or a laser range finder may be used to actually measure the distance.

Again optionally, in the computation step 250, the desired wavelength, power and duration of the laser beam or laser pulse 170 may be computed and communicated to the laser 140. This computation step 250 may take into consideration automated or manual user inputs, the desired engagement level, which may be based on or independent of the characteristics of the flash, as well as external data such as weather conditions. Alternately, this computation step 250 may be skipped if fixed laser settings have been pre-programmed.

Finally, provided that the flash has been determined to be a hostile threat in the classification step 270, the laser is activated in the activation step 260.

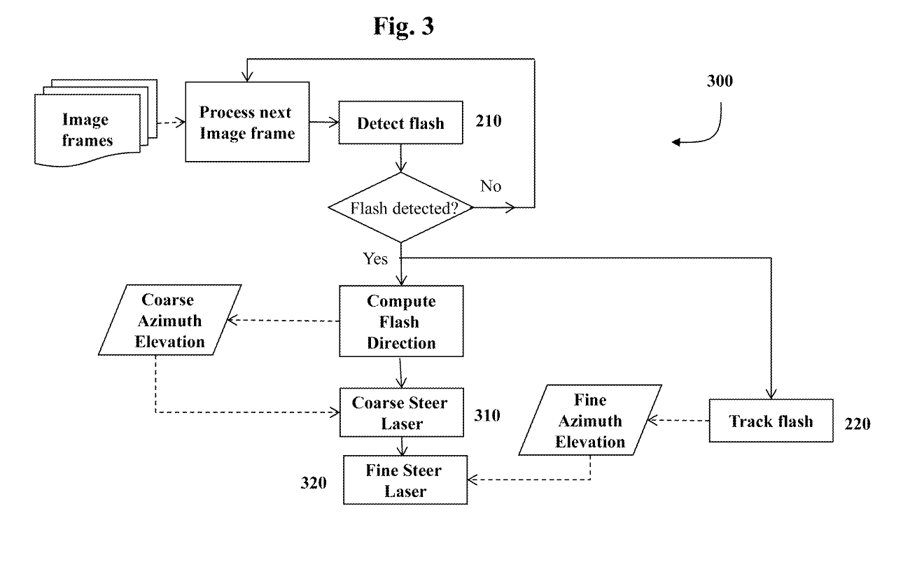

A two step laser steering procedure 300 is further explained in FIG. 3. The flash detection step 210 provides a coarse estimate of azimuth and elevation of the flash source. Once this coarse estimate is known, the steering mechanism 145 is directed to point in that direction in the coarse steering step 310. The fine steering step 320 may then carry out a final fine adjustment of the steering mechanism 145 once the flash tracking step 220 supplies a more precise azimuth and elevation estimate for the flash source.

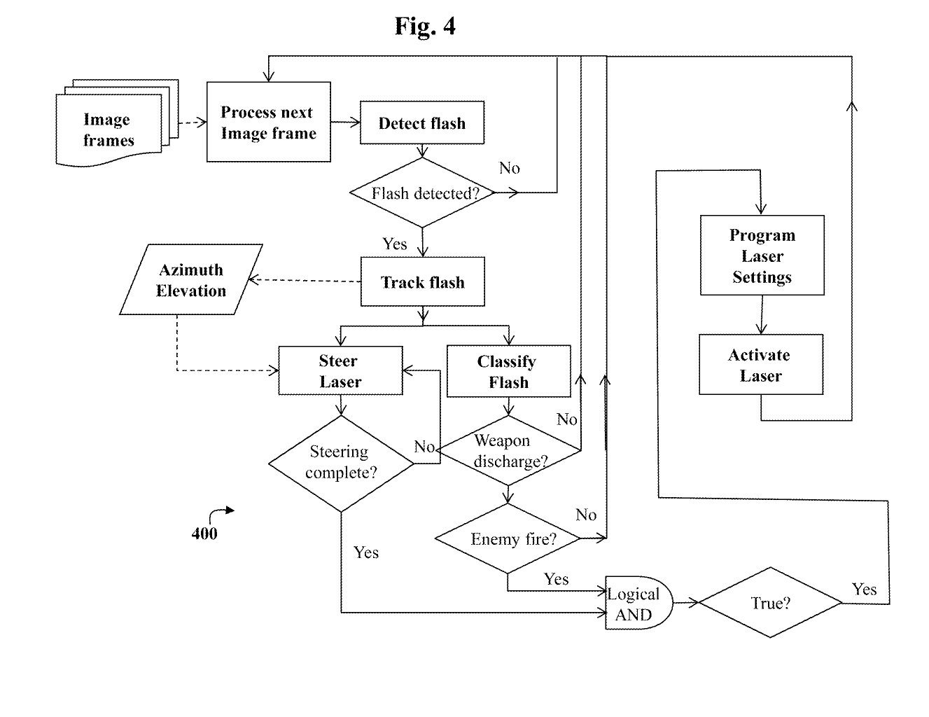

FIG. 4 illustrates another procedure 400 for operating the flash detection and laser response system 100 as a counter-attack weapon. The flash sensor 110 continuously acquires, preferably at 1 KHz or faster, images of the scene. Image frames are analyzed to determine if any flash is present. The determination can be based a threshold intensity. If a flash is detected, its features are analyzed to classify the flash as a natural phenomenon, a non-hostile man-made event, or a weapon discharge. If it is a weapon discharge, it is further investigated to determine if it is friendly fire or enemy fire. This analysis may take into consideration data coming from external sources, such as known positions of friendly and enemy weapons and troops. If it is found to be enemy fire, the flash is tracked using the flash tracker 120 which results in a fine estimate of the azimuth and elevation of the flash source. The azimuth and elevation of the flash are used to steer the laser towards the flash using the steering mechanism 145. At this point optionally, the distance to the flash source may be measured using a laser range finder aimed at the azimuth and elevation calculated using the data from the flash tracker 120. The distance to the flash source may further be estimated from the angular size of the flash. The desired wavelength, power and duration of the laser beam are computed and communicated to the laser source. This process may take into consideration external data such as weather conditions and data from military commanders. Alternately, this step may be skipped if fixed laser settings have been pre-programmed. The laser is then activated.

Another variation that can be used involves programming the laser settings while the steering mechanism is in transit. In that case, the laser is programmed and put on hold. Once the steering mechanism communicates that it has been configured to aim the laser beam towards the flash direction, the laser is activated.

The procedure 400 in FIG. 4 may be modified to include a human decision maker prior to the activation of the laser. Even though this will slow down the response, it may be necessary to prevent accidental firings on friendly forces or people who do not pose a clear and present danger.

Thus, a flash detection and laser response system 100 is disclosed. While embodiments of these inventions have been shown and described, it will be apparent to those skilled in the art that many more modifications are possible without departing from the inventive concepts herein. The inventions, therefore, are not to be restricted except in the spirit of the following claims.

What is claimed is:

1. A flash detection and laser response system comprising:
a flash sensor configured to capture a plurality of sensor images;
an image analyzer configured to identify at least a first image including a flash event, the first image being from among the sensor images, and to compute from the first image a first direction of the flash event relative to the flash sensor;
a laser;
a steering mechanism coupled to the laser and configured to direct disabling light from the laser in the direction of the flash event.

2. The system as in claim 1, wherein the disabling light from the laser comprises a laser pulse.

3. The system as in claim 1, wherein the image analyzer is communicably coupled to the steering mechanism and configured to relay information about the first direction to the steering mechanism.

4. The system as in claim 1, wherein the image analyzer is communicably coupled to the laser and configured to activate the laser.

5. The system as in claim 1, further comprising a flash tracker configured to capture at least one tracker image of the flash event, wherein the image analyzer is further configured to compute from the tracker image a second direction of the flash event relative to the flash sensor, the second direction being more accurate than the first direction.

6. The system as in claim 5, wherein the sensor images the at least one tracker image are time stamped.

7. The system as in claim 5, wherein each of the flash sensor and the flash tracker include a boresight, with the respective boresights being aligned.

8. The system as in claim 1, wherein the image analyzer is further configured to identify a plurality of the sensor images including the flash event and to analyze a time profile of the flash event from the plurality of the sensor images.

9. The system as in claim 1, wherein the image analyzer is further configured to measure an intensity of the flash event.

10. The system as in claim 1, wherein the image analyzer is further configured to measure an angular size of the flash event.

11. The system as in claim 1, wherein the image analyzer is further configured to measure spectral characteristics of the flash event.

12. The system as in claim 1, further comprising a laser range finder configured to be aimed in the first direction and to measure a distance to a source of the flash event.

13. The system as in claim 1, wherein the image analyzer is further configured to determine whether the flash event resulted from a weapon discharge.

14. The system as in claim 13, wherein the image analyzer is further configured to identify a type of weapon from the flash event.

15. The system as in claim 13, wherein the image analyzer is further configured to determine if a friendly weapon caused the flash event.

16. The system as in claim 1, wherein the steering mechanism includes an electrically tunable liquid crystal grating.

17. The system as in claim 1, wherein the steering mechanism comprises an optical beam steering system.

18. A method for operating a flash detection and laser response system, the method comprising:
detecting a flash event using a flash sensor; and
evaluating whether the flash event represents a hostility based on one or more of a direction of the flash event relative to the system, intensity of the flash event, angular size of the flash event, spectral characteristics of the flash event, and if the flash event is determined to represent a hostility,
determining a direction from which the flash event originated, relative to the flash sensor, and
directing disabling light from a laser toward the direction of the flash event.

19. The method as in claim 18, wherein the disabling light comprises a laser pulse.

20. The method as in claim 18, further comprising measuring or estimating a distance to a source of the flash event.

21. The method as in claim 19, further comprising computing operating parameters of the laser based at least partially on the distance to the source of the flash event.

22. The method as in claim 21, further configuring the laser based at least partially on the computed operating parameters.

23. The method as in claim 18, wherein determining the first direction includes determining a coarse estimate of the first direction and a fine estimate of the first direction.

24. The method as in claim 23, wherein steering the laser includes steering the laser first based upon the coarse estimate of the first direction and then based upon the fine estimate of the first direction.

25. The method as in claim 23, wherein the coarse estimate is determined from one or more images generated from a first detector array, and the fine estimate is determined from one or more images generated from a second detector array optically coupled to an interferometric tracker.

26. The method as in claim 23, wherein the coarse estimate is determined from one or more images from a flash sensor, and the fine estimate is determined from one or more images from a flash tracker.

27. The method as in claim 21, wherein the disabling light is configured to temporarily disable an operator of a hostile weapon generating the flash event.

28. The method as in claim 21, wherein the disabling light is configured to destroy a launching weapon platform of a hostile projectile.

29. The method as in claim 21, wherein the disabling light is configured to disable optical instrumentation situated at or near a source of the flash event.
